(19) United States
(12) Patent Application Publication
(10) Pub. No.: US 2006/0034497 A1
(43) Pub. Date: Feb. 16, 2006

(54) Protometric authentication system

(76) Inventor: Michael Manansala, Santa Clara, CA (US)

Correspondence Address: FOOTHILL LAW GROUP, LLP, 3333 BOWERS AVE., SUITE 130, SANTA CLARA, CA, 95054, US

(21) Appl. No.: 10/919,109

(22) Filed: Aug. 15, 2004

(51) Int. Cl. G06K 9/00

(52) U.S. Cl. 382/124

(57) ABSTRACT

A device and method for matching fingerprints and granting or denying access is disclosed. Fingerprints of each potential user are captured by a fingerprint sensor, processed and saved in the device memory. Each fingerprint is converted to a digital image, all fingerprint ridges are thinned and all features except bifurcation points are deleted. The system generates templates of bifurcation points for each person to be enrolled, the template including the coordinates for each bifurcation point and stores the templates in a memory. When a user activates the system by placing his finger on the fingerprint sensor, the system captures the image, digitizes it and determines the coordinates of the bifurcation points. If the match meets the required criteria the user is allowed access. The processing time takes 300 msec or less.

### BACKGROUND OF THE INVENTION

1. Field of the Invention

The present invention relates to an authentication executing device and a method for certifying a user's identity through the check of biometrics, that is, determining one's physical features such as fingerprints to identify an individual and allow an access to that individual or allow an operation to be executed only by that individual.

2. Description of the Related Art

Securing computer systems and electronic transactions is becoming more important as we advance further in the computer age. Existing password and cryptographic techniques have been helpful in solving the security problems of computer systems, electronic commerce and electronic transactions. These approaches assure that the set of digital identification keys associated with an individual person can safely carry on electronic transactions and information exchanges. Typically, a user's input of a password certifies that a person trying to perform a transaction is the authorized user.

One such approach utilizes smart cards. Typical smart card includes an integrated circuit that provides data storage and processing. Most smart cards require an external interface to provide communications, power, and clock cycles. The smart cards may be broken into two major categories: memory cards and microprocessor cards. Memory cards are designed to store and protect information on the card. The cards can hold considerably more data than the magnetic stripes currently on credit cards and provide enough logic to protect that data from unauthorized read and write access.

Microprocessor cards contain a true CPU (Central Processing Unit) and RAM (Random Access Memory) to allow for data processing other than just for protection of data from unauthorized access. Some of these cards specialize in math calculations required for cryptographic function, others are made to support specific programming language, and others are made to do both. Although smart cards are supposed to be “hacker resistant”, they do have several vulnerabilities. One of the approaches used to “break” the smart card secret is differential power analysis which uses statistical analysis of the power used by a smart card during cryptographic functions to determine the secret keys stored on the card. Another approach known as “timing attack”, precisely times private key operations on a smart card and analyzes this information to determine important cryptographic information. Either one of the two approaches mentioned can be done with a relatively limited amount of equipment and access to the card, although both require technical expertise in several areas. Flaws in design or implementation of a card or a system have also been exploited to unlock the card secret.

Today, passwords handle most of the transactional issues. For example, most electronic transactions, such as logging onto a computer system, getting money out of automatic teller machines, processing debit cards, keeping records of employee's work hours, processing debit cards, electronic banking and similar transactions require passwords. Passwords are an imperfect solution because as more and more systems attempt to become secure, a user is expected to memorize an ever expanding list of passwords. Moreover, passwords are relatively easily obtained by observing an individual while entering a password. Furthermore, there is no assurance that users will not communicate passwords to one another, lose the passwords, or have them stolen. Thus, passwords are becoming increasingly less effective as a secure way for performing many transactions.

Little, however, has been done to ensure that such identifications as mentioned above can only be sued by their legitimate owners. This is a critical link that needs to be made secure if secure computer access, electronic commerce, home banking, point of sale, electronic transactions, and similar mechanisms are to become truly secure.

More and more frequently, fingerprint identification is considered. Fingerprints have the advantage of being unique to an individual person, require no memorization and are very difficult to appropriate. Thus, many secure systems have been switching to fingerprint recognition as the means of approving access. A fingerprint identification system looks at the fingerprint ridge patterns or the minutia points. A minutia point is the location where fingerprint ridges begin, end, merge or split. A bifurcation point is a subset of minutia points and it is the location where three fingerprint ridges merge. Fingerprint core is the ridge with the smallest radius

Generally, fingerprint classifications schemes are roughly classified into optical reading schemes and the schemes for converting the three dimensional pattern of a skin surface into an electrical signal and detecting it using human electrical characteristics.

In an optical reading scheme, a fingerprint is received as optical image and collated mainly using reflection of light and a CCD image sensor. Another scheme employees piezoelectric thin film to read the pressure difference in the fingerprint pattern of a finger. Another fingerprint verification approach requires detection of an amount of change in resistance or capacitance using a pressure sensitive sheet.

Fingerprint recognition generally requires the user to place his or her finger on a fingerprint sensing device. Each fingerprint includes a unique arrangement of ridges and grooves. The fingerprint sensing device transmits an analog image of the user's fingerprint, via a coaxial cable, to a computer system. The computer system then matches the fingerprint to a database of fingerprint templates in the computer system. Typically, the computer compares the minutiae points, i.e., the points at which a ridge in a fingerprint pattern ends or at which two ridges meet to the minutiae points for the corresponding finger in the computer memory. When there is an exact correlation, or an acceptably high degree of correlation, between the minutiae points of the user to that to the print found in the computer memory, the identity of the person is positively established. While this is an improvement over a password driven approach, there are a number of problems with the existing fingerprint identification methods.

One of the disadvantages of fingerprint sensing devices is that such devices are generally bulky. This makes it difficult to adopt such devices to portable computers, consumer electronics, or in any situation where space is limited.

Moreover, fingerprint sensing devices generally require a connection to a power outlet in addition to the connection to the computer, thus consuming an additional power outlet. This creates limitations in situations where additional outlets are not available.

Furthermore, since conventional fingerprint devices generally transmit an analog image of the fingerprint, via coaxial cable, security may be breached. The analog fingerprint image may be obtained by intercepting the image transmitted on the coaxial cable. Thus, if a false user had an image capturing device, such user may be able to impersonate an original user by resending the captured image. This reduces security in cases where the actual fingerprint sensing procedure is not observed by anyone, which is so in vast majority of situations. Also, since the fingerprint processing in conventional systems generally takes place in the computer system, the computer system itself can be corrupted to defeat the security provided by the fingerprint sensing device. At the end of the fingerprint sensing process, the computer system decides whether the fingerprint received from the fingerprint sensing device matches a fingerprint in the data base. Either the data base can be altered or the process which matches the print to the database can be altered to send a false positive identification. This essentially destroys any advantages of the fingerprinting system.

The conventional system requires the user to interact with the fingerprint sensing system. A typical process requires a user to position his finger on the sensing sensor platen. An image of the fingerprint is displayed on a computer monitor with a cross hair. The user is asked to position a finger such that the cross hairs are centered, and that the print is clearly displayed. When the user has determined that the image is in proper position, the user must press a button to indicate that that this is the image to be transmitted. Once the user has selected the proper fingerprint, the device takes an image and sends it to computer for processing. This awkward and error prone procedure requires active participation and control by the user. It would be advantageous if such interaction were not required.

The accuracy of conventional fingerprint devices is also compromised if the user's fingers are too dirty, too rough, too smooth, or too oily. Many conventional fingerprint devices take a picture of the finger which was placed on the sensor plate. Locations where there is a direct contact with the sensor platen, such as a ridge on a finger, do not reflect the light, but rather absorb it. Locations where there is nothing contacting the sensor platen, such as grooves in the fingerprint, reflect the light. This produces an image of absorbed and reflected light on the sensor platen. As is usuall the case, dirt and smudges on the sensor platen can also absorb the light, thus producing a false image. The image taken represents all the dirt and smudges on the sensor platen in addition to showing the actual fingerprint. One approach pursued in solving this problem uses stronger light to break through the dirt and the smudges and thus some light is reflected even in case of residue on the sensor platen. The disadvantages of this approach are that it requires more power and will not pick up the fingerprints which are not perfectly clear. If, for example, the user's finger is dry, the ridges are not well defined, and the brighter light may not pick them up.

Current generation fingerprint devices generally scan a fingerprint and transmit the image through a serial connection to a personal computer (PC). These devices require the use of software that is installed on a PC having at least a Pentium class microprocessor operating at 200 MHz or above in order to process the fingerprint image and perform enrollment, verification and database functions. More particularly, known algorithms for performing such functions are sufficiently computationally intensive that only a relatively powerful microprocessor can perform the operations necessary to identify a fingerprint in a commercially reasonable period of time. For instance, known algorithms use functions such as Fourier transforms and complete image-to-image comparisons, which require substantial computing power to execute in a reasonable period of time. Requiring a PC to process a fingerprint image adds to the expense of such devices and makes them unusable to owners of portable computing, communications and other devices, and generally diminishes the applications in which they can be used.

Also known in the art are fingerprint identification devices that contain embedded or autonomous fingerprint capture and verification software and thus do not require a PC to process the fingerprint image. One such device is Sony® FIU fingerprint identification unit. The power requirements of these devices, however, are substantial and require an external power supply which diminishes their portability and convenience and their usability with PDAs, cellular telephones and other portable devices.

Ultimately, in fingerprint recognition techniques existing presently, the fingerprint image obtained by the fingerprint sensor must be compared with the user fingerprint data registered in advance. For the correlation to take place, feature points of the fingerprint image are extracted and compared with the registered points, or the fingerprint image is directly correlated with the registered image. To successfully complete the correlation, a fingerprint recognition apparatus coupled with a high performance microprocessor is typically employed.

A common disadvantage to all of the aforementioned techniques is that they typically require large amounts of memory, employ lengthy computational techniques, require a number of seconds to process the information fingerprint, have difficulties adopting to the changes in the surface conditions of the enrolled user's fingerprint and tend to be costly. Typical memory size required for one finger using a 256 by 300 pixel capacitive sensor is 76.8 Kbytes per template created. Since typically three templates are created per finger, the total memory required is 230.4 Kbytes per finger.

Consequently, there is a need for a fingerprint recognition system that is compact in size, affordable, has short processing time (300 milliseconds or less), requires minimal amount of memory, is capable of processing more than one fingerprint simultaneously, readily adopts to the changing conditions in the users' fingerprint and easily integrates additional functionality. The invention disclosed herein meets such need.

### SUMMARY OF THE INVENTION

In accordance with the present invention a fingerprint identification system is disclosed.

It is one aspect of the present invention to provide a secure access to a unit connected to the device. The device includes a biometric sensor capable of sensing a biometric trait of a user that is unique to the user and providing a signal containing the information representing that biometric trait. The processing unit receives the signal and compares the information to the biometric data stored in the memory and representing biometric trait of an enrolled person. If the information from the sensor matches up with the information stored in the memory, the user is identified as an enrolled person and the access is granted to the unit secured by the device. The processing unit completes this transaction in 300 milliseconds (ms) or less from the time the fingerprint sensor is activated. This compares favorably with the prior art that typically takes several times longer. The device is capable to process the transaction in such short period of time because only bifurcation points of the fingerprint image are stored and compared to the bifurcation points from the image supplied by the sensor. The device normally processes 20 bifurcation points per transaction. Consequently the memory requirements are also quite small. As a result it is possible to enroll several fingers without straining memory resources. Typically, a nonvolatile memory is employed. Additionally, the device may be interfaced with a camera to take a picture of the user after the fingerprint has been authenticated.

In another aspect of the present invention, the device is capable of maintaining time records for each user and transferring this information to a spread sheet, thus keeping record of time worked if desired. This data can then be supplied to a data processing unit for salary calculation or similar transaction.

It is another aspect of the present invention to compensate for variations in fingerprint conditions by performing dynamic calibration to compensate for different degrees of fingerprint surface roughness, moisture, etc.

In another aspect of the present invention, the device is capable of processing multiple finger images by multiplexing inputs from a number of sensors to the processing unit. This enables the user to gain access in case one or more fingers cannot be successfully compared to the images in the memory.

Still another aspect of the present invention is a method of creating a template containing attributes of a fingerprint unique to a person, the method comprising the steps of: capturing the finger image, transferring the image to a processing unit, converting the image to a binary image, thinning the binary image, locating the core of the finger, locating 20 bifurcation points and determining their coordinates, eliminating defective bifurcation points, storing this information in the memory, comparing the distance between the stored data coordinates and the the coordinates of the image obtained from the user, and granting or denying the access as appropriate.

These and other aspects and advantages of the present invention will become more apparent after considering the ensuing description, accompanying drawings and the appended claims.

### BRIEF DESCRIPTION OF THE DRAWINGS

FIG. 1 is a general block diagram of the system

FIG. 2 is a typical raw fingerprint image

FIG. 2A is a typical binarized image

FIG. 2B is a typical thinned image

FIG. 3 shows features of a fingerprint ridge

FIG. 3B shows the details of minutia (bifurcation and endings)

FIG. 4 shows the excluded fingerprint patterns

FIG. 5 is the general system flow chart

FIG. 6 shows bifurcation points with X,Y,θ coordinates

FIG. 7 is a block diagram for multiple finger scan device operation

### DETAILED DESCRIPTION

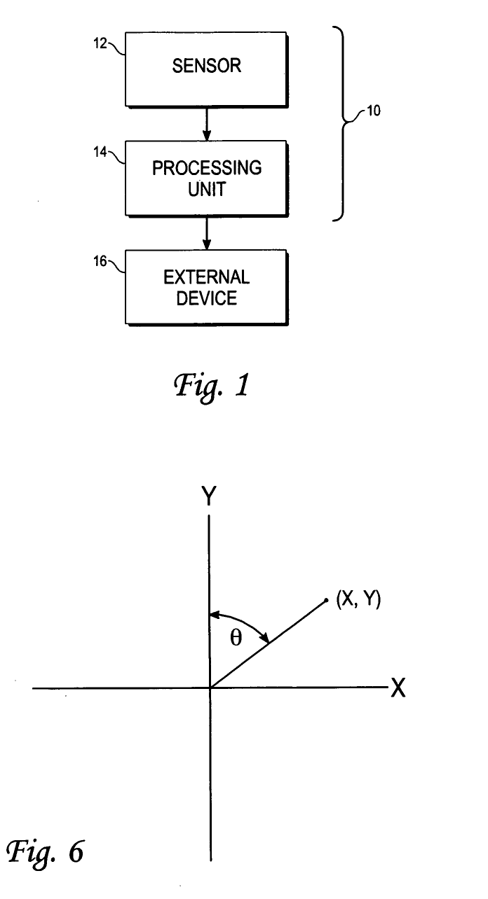

Referring to FIG. 1, the disclosed invention is fully self contained fingerprint verification device 10. As shown in more detail below, the device 10 permits rapid enrollment of multiple fingerprints and likewise rapid verification to determine if the fingerprint of the user corresponds to a previously enrolled finger. As used herein, the term fingerprint also includes thumbprints and toe prints.

The device 10 includes the fingerprint sensor 12 and the processing unit 14. The device 10 is designed to provide access to the external unit 16, the unit 16 being connected to the device 10 via an appropriate commercially available interface. Virtually any type of external unit 16 may be used with the device 10, as an example but not as a limitation, external unit 16 may be a door locking mechanism, computers, calculators, personal digital assistants, communications and portable communications devices, security systems such as those used in a home, business, automobile, weapons and any other device where it is desired to restrict access to only previously authorized persons. The fingerprint sensor 12 provides raw image of a fingerprint positioned proximate to the sensor. The relative proximity of the fingerprint to the sensor 12 will depend on the type of the sensor used. With some sensors. e.g., capacitive type, the fingerprint will need to be brought into intimate contact with the outer surface of the sensor 12, whereas with the others, such as optical types the fingerprint will need to be positioned within approximately 2-5 mm of the outer surface. As used herein, “proximate” includes both positioning the finger in the direct contact with the outer surface of the sensor and positioning the finger near, but spaced apart from the outer surface of the sensor.

In one embodiment of the present invention, sensor 12 may be a capacitive fingerprint sensor with a matrix of 256 by 300 pixels, 8 bit gray scale, 500 dpi (dots per inch) pixel resolution. A person skilled in the art will be able to choose the appropriate technology for sensor 10, but other types of fingerprint sensors, such as an optical sensor may also be used.

The device 10 may be connected to the external unit 16 by any wired or wireless connection. The device 10 and the external unit 16 may be spaced apart or they may be integrated in one unit. The device 10 is typically powered by an external power source, such as line power.

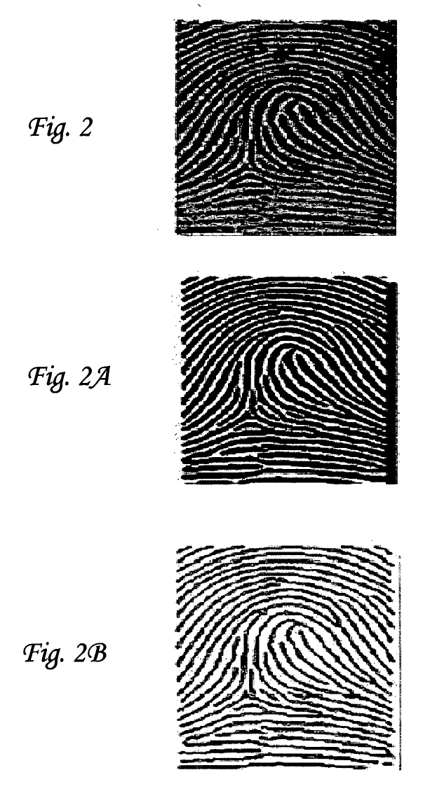

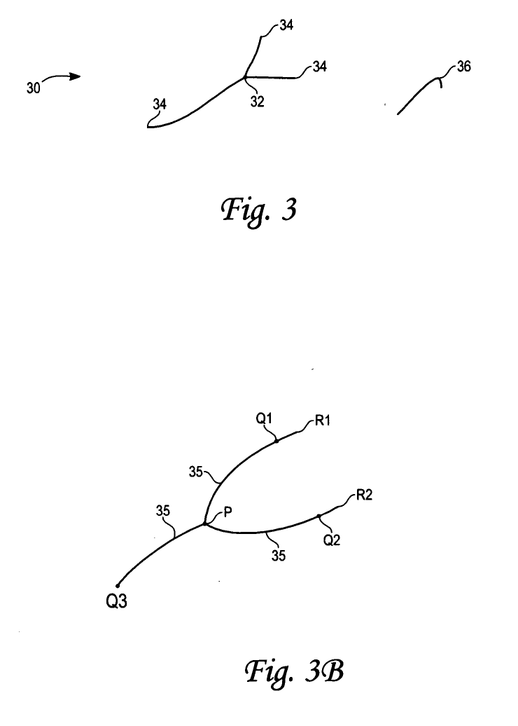

Referring now to FIG. 2, an actual fingerprint raw image 20 is shown. The features of image 20 that the disclosed invention seeks to identity are shown in FIG. 3, wherein 30 is the fingerprint ridge, 32 is bifurcation point, 34 are the fingerprint ridge end or start points and 36 shows a radius of a fingerprint ridge 30. Collectively, the bifurcation point 34 and end or start points 34 are referred to as the fingerprint minutia. The fingerprint ridge with the radius 36 smaller than all the other fingerprint ridges is referred to as the fingerprint core.

FIG. 3B shows the criteria for selecting valid bifurcation points that are obtained by following the fingerprint ridge 30 contour that has at least three lines 35, point P and end points Q1, Q2 and Q3. For a point P to qualify as a bifurcation point, the distance from P to Q3 has to be greater than or equal to the distance from P to Q1 and P to Q2. Points Q1 and Q2 may be located anywhere along the lines 35 so long as the distance requirement of this paragraph is satisfied.

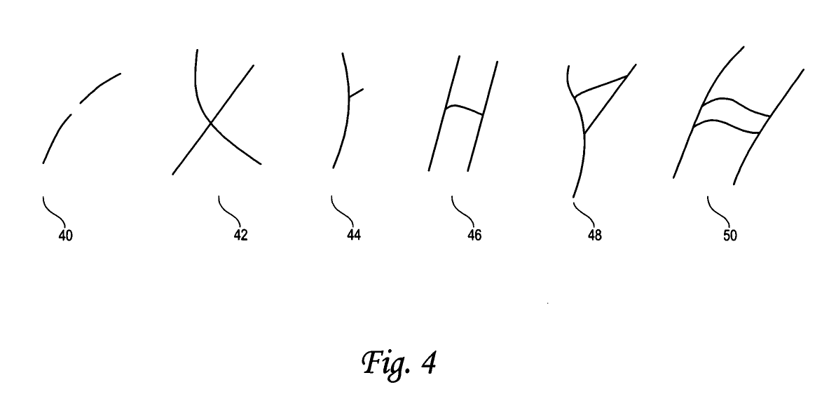

Shown in FIG. 4 are the fingerprint patterns that do not qualify as the minutia and that the invention disclosed herein intentionally excludes. Shown: are close endings 40, crossing point 42, spike 44, bridges 46, triangle 48 and ladder 50.

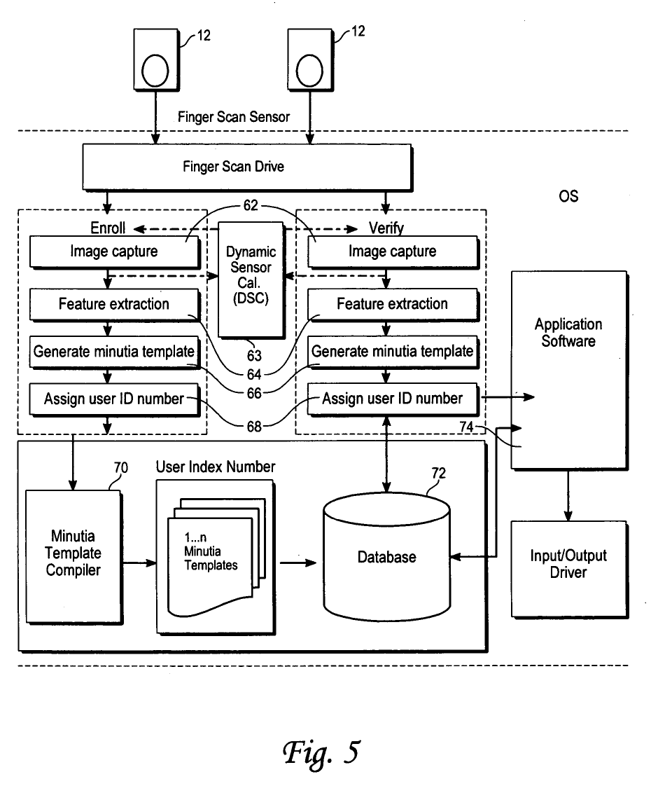

Shown in FIG. 5 is the general enrollment and verification flow chart 60. The algorithm showing the details of the image processing and verification will be found in the Appendix A. The flow chart 60 includes one or more finger sensors 12 that capture raw image 62. Typically, at least one or all 10 fingers may be enrolled. Each finger is preferably placed on the surface of the sensor 12 three times to better capture variations in the fingerprint positions that a typical user may experience and three templates are generated for each finger, typically occupying 230.4 Kbytes of memory using the sensor with 256 by 300 pixel resolution. The sensor 12 then undergoes a dynamic calibration process 63 (described in more detail under the heading “Dynamic Sensor Calibration”) to accommodate varying skin surface conditions. The raw image 62 is then subjected to minutia extraction routine 64. The routine 64 binarizes the raw image 62 by assigning a digital “1” to each fingerprint ridge and digital “0” to each fingerprint valley. This process also eliminates the image 62 gray scale and improves the contrast ratio between the fingerprint ridges and valleys for better feature discernment. The binarized image is then “thinned” by reducing the width of each fingerprint ridge 30 by one half, i.e., in this case the ridge 30 is reduced from the width of 50μ (full pixel size) to the width of 25 μm (one half pixel size). Thinning the ridge lines 30 also succeeds in eliminating some of the false minutia. The binarized image is further examined for the ridge 30 consistency and the thinning process may be repeated if there are, e.g., too many lines that are far thinner than the others and may appear as broken, thus unnecessarily eliminating them from further considerations. The routine 64 than searches for the fingerprint core 36 and bifurcation points 34 located around the core 36 and generating minutia template 66. The core 36 is defined as the ridge with the smallest radius. Turning again to FIG. 3B, for a point P to qualify as a bifurcation point, the distance from P to Q3 has to be greater than or equal to the distance from P to Q1 or P to Q2. Points Q1 and Q2 may be located anywhere along the lines 35 so long as the distance requirement of this paragraph is satisfied. A binary “1” is assigned to each bifurcation point and a binary “0” to each ridge 30 ending. Preferably, 20 bifurcation points 34 per fingerprint image are recorded although satisfactory fingerprint verification results may be obtained with 8 and with as few as 5 bifurcation points 34. The system records X and Y coordinates (X varying from 0 to 255 pixel and Y from 0 to 299 pixel in case of the capacitive sensor chosen here) for each bifurcation point 34 and the core 36. An angle θ coordinate may optionally be chosen if desired with the angle being measured relative to the Y axis and ranging form 0 to 360 degrees. The selected bifurcation points are then grouped onto a minutia template 66. Optionally, a user identification (ID) number 68 is assigned to each user. All the minutia templates 66 are then compiled into a memory 70. The memory 70 is preferably a nonvolatile memory such as an EEPROM (electrically erasable programmable read only memory) in order to reduce possibility of data loss. Alternatively, flash memory or a volatile memory may also be used. Each bifurcation point consumes 4 bytes of memory for a total of 80 bytes per template and 240 bytes per an enrolled finger. Such low memory requirements enable the verification device 10 to enroll many users and possibly all 10 fingers per user and still store all the data in the memory without resorting to a hard drive memory storage. Enrolling more than one finger per user allows for user verification in cases where the only enrolled finger has been damaged and cannot be verified. Storing the data in an EEPROM allows for much quicker access and shorter processing times. Preferably, the data on the most recent or frequent users is stored in the EEPROM and the remainder on the hard disc drive 72. The ability to store large amount of data on the EEPROM enables the verification time to be 300 msec or less if fewer bifurcation points 32 are selected. The user will have to determine the degree of accuracy desired. False verification rate with 8 bifurcation points is ⅓×10⁶ and for 20 bifurcation points it is ⅙×10⁹. The processing time for 5 bifurcation points is 75 msec.

The fingerprint verification process follows the steps just described above through step 66 and the user may place just one finger onto the sensor 12 or multiple fingers if more than one sensor 12 is employed. At this point the template matching software 74 is employed to compare the template 66 just created for the user to the data base of all templates stored in the EERPOM memory 70 or the hard disc drive 72 and determine if there is a match. The template matching software compares the X,Y and optionally θ coordinates of the enrolled templates to those just obtained from the user, with X,Y being the stored coordinates and X′,Y′ designating the user coordinates. The following formula is employed: Max. distance=D=√(x′−x)²+(y−y)². The maximum allowable distance is presently 50 μm (micrometers) and is the function of the minimum pixel size (D₀). The user will be allowed access if: 0μ<D≦50 μm

Optionally, if the angle coordinate is also chosen, than the angle difference between the stored coordinates and the user coordinates is determined. The bifurcation points 32 recorded on the first template during the enrollment serve as the reference point for the remaining minutia during the enrollment. The difference (Δ₁) between the angles of the first recorded bifurcation point 32 during the first finger scan and the same bifurcation point 32 recorded during the second finger scan is recorded. When the user's finger is scanned, the angle difference between the same user's bifurcation point 32 and the first bifurcation point 32 recorded during the first finger scan during the enrollment (Δ₂) is measured. Δ₁ must be different from Δ₂ for the access to be granted. FIG. 6 shows the coordinates of a typical bifurcation point 32.

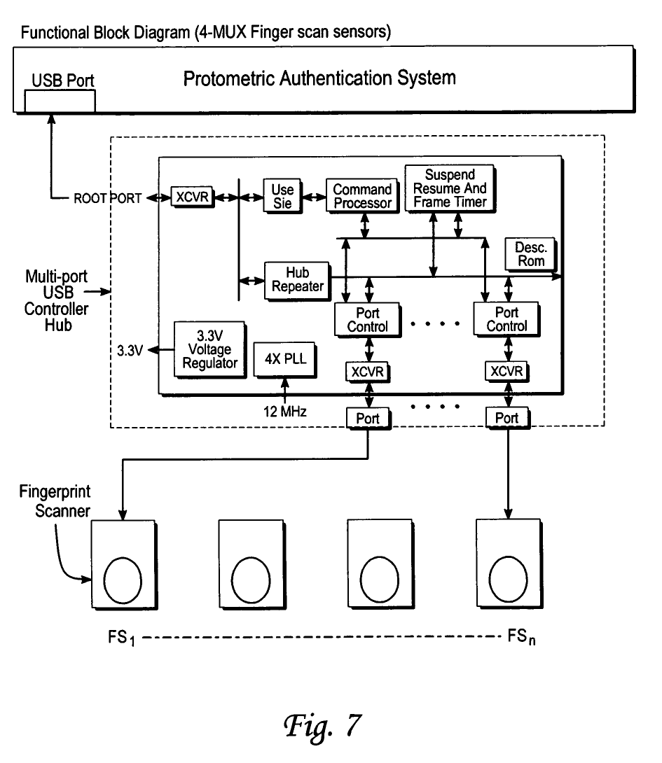

Since the verification device 10 is capable of storing images from several fingers, it can likewise compare images coming from multiple fingers in the order that the fingers made contact with the sensors 10. This can be accomplished by using commercially readily available single chip USB hub controller, such as Alcor Micro Corp device AU9254A21 that enables a user to place several fingers on several sensors. The images are processed sequentially. A clear advantage of this approach is in that if one finger is rejected, the system will continue processing and allow the access to the user based on matches from the other fingers. A typical arrangement is shown in FIG. 7.

The algorithms employed in this invention operate on Windows 98 or a more recent platform and could readily be adopted to other platforms.

### Dynamic Sensor Calibration

The verification device 10 is also capable of compensating for varying conditions of fingertip surface, such as roughness and moisture content.

Basic components of the capacitive sensor technology consist of two adjacent metal plates and active feedback circuit as shown in the figure below. The capacitance between the sensor plate (a pixel) and the actual finger is being measured (finger being the second plate of the capacitor). Each metal plate (pixel) is pre-charged to a reference discharge current I_{ref}. This relation is best expressed as; Iref=C dv/dt, where dv/dt is the rate of change with time of electrostatic voltage existing in the user, and C is the capacitance.

[image]

The capacitance of the fingerprint valley is lower than that of the fingerprint ridge. (DSC) Dynamic Sensor Calibration software routine provides auto-calibration of finger sensor DC (discharge current) parameters based on finger moisture condition that is directly proportional to the finger image contrast by initially presetting the sensor pixel array dv (discharge voltage), dt (discharge time), and PGC (programmable gain control) levels to the desired target Mean. The gain table provides high, moderate and low gain adjustments for desired target Mean values. The software dynamically re-adjusts and tunes the sensor DC parameters after every subsequent finger image capture routine. The software algorithm correlates the sensor DC parameters against the images after each subsequent image scan using one set of DC parameters for Wet, Dry and Normal finger types to properly handle range of finger types or conditions.

The Dynamic Sensor Calibration software uses a single API function, SensorAdj( ), for integrating with high-level image capture routines. The sensor is initialized to default settings when opening the sensor device and calibrating the sensor ADC (analog digital converter) output to=˜250 decimal with “No Finger” applied to sensor array. This default setting will provide a good contrast image for most finger types. Fine-tuning the sensor to various finger types (Wet, Dry or Normal) calibrates the ADC output to=˜200 decimal with “Finger” applied to sensor surface providing Automatic Gain Control (AGC) control to specific finger type.

### Software Routine

The software obtains image contrast settings by averaging the 8-bit ADC output from the sensor's selected pixels on the center rows. When placing a finger on the array, the finger ridges produces low ADC outputs toward a value of “0” (gray to black) and the fingerprint valleys produces high ADC outputs toward a value of “255” (gray to white). Targeting an array Mean towards a value of 200+/−20 with the finger on the sensor is the basis for the image calibration software. The amount of moisture in a finger will result in high to low target means and affect gain settings. Ideally, only one calibration setting Discharge Current (DC), Programmable Gain Control (PGC), and Discharge Time (DT) is adjusted after each captured image to minimize overhead and stability issues. If a finger is not detected during auto calibration then the software may still adjust calibration settings to maintain average grayscale outputs of=˜250 ADC output.

Auto-Cal software optimizes image contrast by adjusting one of the following calibration registers: DC, DT, or fixed PGC. Auto-Cal ranges settings were selected to maintain a hierarchical gain structures from DC, PGC and DT settings providing the High, Moderate and Low gains respectively with full ADC output range (0 to 255). Choosing higher DT values (>4) and modifying ADC array Mean outputs less to than 160 changes the Auto-Cal gain structure between DC & DT, higher DT values cause an increase in ADC output. Choosing higher values of DC or DT will cause quicker discharge of cells resulting in lighter or white cells toward 255 ADC output.

Data capturing process consists of 2 steps: the row capture and column capture. The row capture starts once the targeted row is selected and one of the 3 GETXXX bits, i.e. GETIMG, GETSUB and GETROW, is set. The row capture includes the sensing cells pre-charge and discharge procedures. The discharge time is programmable by writing to DTR register. When the row capture is completed, the sensed data for each pixel in the selected row is recorded and ready for column capture.

The column capture then begins. The on-chip auto-incrementor steps through each column, and the ADC processes each recorded value. So the sensing result is ready on ADC output for reading after each column capture. Therefore, it takes 1 row capture and 256 columns captures to complete a row data acquisition. The auto-incrementor will step down to the next row once it has completed the current row. It then repeats the procedures as mentioned above. The sensor will loop back to the 1st row once the last row of the array is completed.
DC: Discharge Current
Sets the devices discharge time using. Auto-cal software uses DC settings between 2 & 4 with default setting of DC=2 during initialization. Incrementing DC causes ADC output to lighten toward 255.
PGC: Programmable Gain Control
Sets the array sensitivity. Auto-cal software uses PGC setting between 11 & 15 for programmable gain settings of 2.0-7.0. The default setting is 12 for 3.0 gain setting when initializing Auto-Cal defaults. Incrementing PGC causes ADC output to darken toward 0.
DT: Discharge Time
Sets the devices discharge time. Auto-cal software uses DT settings between 1 and=˜75 or the maximum DT setting defined in the Auto-cal gain tables. The initial DT default is 30 however this setting is adjusted when initializing a blank or “No Finger” sensor ADC output to=˜250. Increment DT causes ADC output to lighten toward 255.
   The complete software routine for dynamic calibration is shown in Appendix B.

[image]

[image]

[image]

[image]

[image]

[image]

[image]

While the present invention has been described in considerable detail and in connection with preferred embodiment, it will be understood that it is not so limited. On the contrary, it is intended to cover all alternatives, modifications and equivalents as may be included within the spirit and the scope of the invention as defined in the appended claims.

What is claimed is:

1. A biometric fingerprint authentication device comprising:
A sensor capable of sensing a biometric trait of a user's finger that is unique to said user and providing a first signal containing information representing said biometric trait;
and a processing unit having memory and coupled to said sensor and capable of receiving said first signal, said processing unit adopted to form binary image of said biometric trait and further process said binary image and extract the core of said biometric image and at least one bifurcation point from said biometric image, said at least one bifurcation point having at least first, second and third segment, said at least first, second and third segment each further having the first and second end and the second end of said first, second and third segment all converging at one point, the length of said first segment being equal to or greater than the length of said second or third segment, said processing unit generating a template with all bifurcation points with X-Y coordinates for each said bifurcation point, said processing unit further adopted to compare said information from said sensor to biometric data of at least one finger stored in said processing unit memory and representing a biometric trait of an enrolled user and provide a verification signal indicating whether or not said information corresponds sufficiently with said stored biometric data to verify that said user is said enrolled person;

2. The device of claim 1 wherein said processing unit further sends said verification signal to an access control device, said access control device capable of allowing and not allowing access to said enrolled user.

3. The device of claim 1 wherein said processing unit is coupled to a time calculation unit, said time calculation unit capable of calculating the time difference between each sensing event of said enrolled user.

4. The device of claim 3 wherein said time calculation unit is a Windows based spread sheet.

5. The device of claim 1 wherein said device is adopted to operate with an 8 bit microprocessor.

6. The device of claim 1 wherein said processing unit further comprises only a non-volatile or volatile memory for storing said biometric data representing said biometric trait, said processing unit being fully functional without a hard storage medium.

7. The device of claim 1 or 6 wherein said processing unit completes said comparison and generates said verification in 300 milliseconds or less.

8. The device of claim 1 wherein said at least one bifurcation point is at least 5 bifurcation points.

9. The device of claim 1 wherein said at least one bifurcation point is 20 bifurcation points.

10. The device of claim 1 wherein said processing unit enrolls at least 20 bifurcation points for each user.

11. The device of claim 1 wherein said processing unit stores a bifurcation point of a fingerprint of an enrolled person employing no more than 4 bytes of data.

12. The device of claim 1 wherein said processing unit stores the biometric data of more than one fingerprint of the same fingure.

13. The device of claim 1 further comprising dynamic calibration capability, said dynamic calibration being capable of adopting to varying finger conditions.

14. The device of claim 1 wherein said sensor and processing unit are further adopted to accept more than one fingerprint.

15. The device of claim 1 where said processing unit is an 8 bit microprocessor.

16. The device of claim 1 further adopted to eliminate defective bifurcation point.

17. The device of claim 1 further adopted to send said verification signal to a photographic system and activate said photographic system.

18. The method for fingerprint authentication, said method comprising the steps of:
(a) placing a finger on the sensor;
(b) capturing the image of the at least one finger;
(c) transmitting said image to said processing unit;
(d) converting said image to a binary image;
(e) thinning said binary image
(f) determining the core of said finger;
(g) locating at least 20 bifurcation points;
(h) determining the coordinates (x, y) of said bifurcation points;
(i) generating a template of bifurcation points;
(j) eliminating defective bifurcation points;
(k) repeating the steps (a) through (j) two more times with the same finger and storing said bifurcation points in memory, thus enrolling the user.
(l) repeating the steps (a) through (k) for additional fingers and storing at least 20 bifurcation points for each finger in the memory.

19. The method for finger authentication further comprising steps of:
(a) placing a finger on the sensor;
(b) capturing the image of the at least one finger;
(c) transmitting said image to said processing unit;
(d) converting said image to a binary image;
(e) thinning said binary image
(f) determining the core of said finger;
(g) locating at least 20 bifurcation points;
(h) determining the coordinates (x′, y′) of said bifurcation points;
(i) generating a template of bifurcation points;
(j) eliminating defective bifurcation points;
(l) calculating the distance between the coordinates of the enrolled bifurcation points and the bifurcation points of the finger of the user just imaged, such distance being calculated by:
maximum allowable distance=√(x−x′)²+(y−y′)²
(m) generating a signal that allows the access to said user if the distance is less than the size of one pixel for the sensor being employed.

20. The device of claim 18 or 19 wherein the coordinates further include an angle coordinate of the bifurcation point of the user, said angle measured relative to the y-axis, the difference between said angle of said user and the angle of the first stored said bifurcation point is not zero when subtracted from the difference between the angles of said first stored bifurcation point and second stored bifurcation point.
